(19) United States
(12) Patent Application Publication
(10) Pub. No.: US 2003/0061894 A1
(43) Pub. Date: Apr. 3, 2003

(54) Joystick

(76) Inventor: Yoshiro Itagaki, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/255,584

(22) Filed: Sep. 27, 2002

(30) Foreign Application Priority Data
Sep. 28, 2001 (JP) P2001-304259

(51) Int. Cl. G05G 13/00

(52) U.S. Cl. 74/471 XY

(57) ABSTRACT

A joystick has a knob and an operation stick. The knob has a insertion hole. The knob is provided with a first restriction portion on an inner face of the insertion hole. The operating stick has a second restriction portion. The operating stick press-fits into the insertion hole. The first restriction and the second restriction portion restrict a press-fitting direction when the operating stick is press-fitted into the insertion hole.

### BACKGROUND OF THE INVENTION

This invention generally relates to a joystick and, more particularly, to a joystick, which is constructed so that arms provided in a casing are swung by an operation of an operating stick, and which undergoes improvements on the shapes of the operating stick, casing, and arms thereof thereby to be prevented from being misassembled.

A related joystick of such a kind is described with reference to FIGS. 8A and 8B. In these figures, reference numeral 1 designates a joystick. The joystick 1 is configured so that arms 3 and 4 perpendicular to each other are swingably disposed in the casing 2 in such a way as to be upwardly or downwardly apart from each other. Further, each of the arms 3 and 4 is pivotally supported at both end portions thereof in the casing 2, and connected to a corresponding one of variable resistors 5 and 6 at an end portion thereof.

Further, each of elongated holes 7 and 8 respectively extending in the axis directions of the arms 3 and 4 is bored in the central portion of a corresponding one of the arms 3 and 4. An operating stick 9 is provided in such a manner as to penetrate through the elongated holes 7 and 8. Moreover, the bottom end portion of the operating stick 9 is formed as a convex spherical portion 9a. On the other hand, a concave spherical portion 10a is formed in the central part of the bottom plate 10 of the joystick 1. The convex spherical portion 9a is swingably put on the convex spherical portion 10a. Incidentally, a knob (not shown) is fitted into the top end portion of the operating stick 9.

Thus, when the operating stick 9 is operated, the operating stick 9 swings around the concave spherical portion 10a employed as a swinging fulcrum. Consequently, the arms 3 and 4 are swung, and the variable resistors 5 and 6 respectively connected to the arms 3 and 4 are turned. Thus, the variable resistors 5 and 6 generate outputs in response to an operation of the operating stick 9.

The related joystick is constructed so that the arms perpendicular to each other are swingably disposed in the casing in such a way as to be upwardly or downwardly apart from each other, that each of the arms is pivotally supported by the casing at both end portions thereof, and that one of the end portions of the arms is connected to a corresponding one of the variable resistors.

Further, each of the elongated holes respectively extending in the axis directions of the arms is bored in the central portion of a corresponding one of the arms. The operating stick is provided in such a way as to penetrate through the elongated holes.

However, in the case of the related joystick, there is a fear that at assembly thereof, various kinds of misassembly thereof may occur owing to similarity in the assembling direction among components thereof. For example, when the two arms get pivotally supported in the casing, there are fears that the assembly thereof is performed by taking the two arms for each other, and that the arms are assembled by being reversed left to right. Furthermore, when the operating stick is provided in such a way as to penetrate through the elongated hole in each of the arms, there is a fear that the operating stick may be provided therein by being reversed left to right in such a way as to penetrate therethrough.

Further, there is a fear that the operating stick may be press-fitted into the knob in an incorrect direction.

### SUMMARY OF THE INVENTION

It is therefore an object of the present invention to provide a joystick which enables to prevent components of a joystick from being misassembled.

In order to achieve the above object, according to the present invention, there is provided the joystick comprising:

a knob, having a insertion hole, provided with a first restriction portion on an inner face of the insertion hole; and

an operating stick, having a second restriction portion, press-fitting into the insertion hole;

wherein the first restriction and the second restriction portion restrict a press-fitting direction when the operating stick is press-fitted into the insertion hole.

In the above configuration, the provision of the restriction portion enables the assembly of the operating stick without mistakes.

Preferably, the first restriction portion is a recessed portion formed on the inner face of the insertion hole; and

wherein the second restriction portion is a protrusion formed on the operating stick so as to fit on the recessed portion.

In the above configuration, the press-fitting direction of the operating stick can be restricted by the protrusion and the recessed portion. Consequently, the joystick enables the assembly of the operating stick without mistakes.

According to the present invention, there is also provided a joystick, comprising:

an operating stick, having a third restriction portion; and

an arm, having an elongated hole extending in a longitudinal direction thereof, the arm provided with a fourth restriction portion formed on an inner face of the elongated hole;

wherein the third restriction portion and the fourth restriction portion restrict the penetration direction when the operating stick penetrates the arm through the elongated hole.

In the above configuration, the penetrating direction of the operating stick can be restricted by the third and fourth restriction portions. Consequently, the operating stick can be prevented from being misassembled.

Preferably, the third restriction portion is a first protrusion formed on the operating stick in the longitudinal direction;

wherein the fourth restriction portion is a second protrusion formed on the inner face of the elongated hole in the longitudinal direction so as to prevent from interfering the first protrusion with the second protrusion when the operating stick penetrates into the arm through the elongated hole in a predetermined direction.

In the above configuration, the penetrating direction of the operating stick can be restricted by the first protrusion and the second protrusion. Consequently, the operating stick can be prevented from being misassembled.

According to the present invention, there is also provided a joystick, comprising:

a casing; and

an arm, supported on the casing at end portions of the arm so as to be pivotable, the arm having a fifth restriction portion to restrict a supporting direction of the arm with respect to the casing.

In the above configuration, the arm can be prevented from being misassembled.

Preferably, the fifth restriction portion is the end portions of the arm in which diameters of the end portions have different diameters.

In the above configuration, the arm can be prevented from being misassembled.

According to the present invention, there is also provided a joystick, comprising:

a knob, having an insertion hole, provided with a recessed portion on an inner face of the insertion hole;

an operating stick, having a first protrusion, press-fitting into the insertion hole, having a second protrusion extending in a first direction;

casing; and

an arm, supported on the casing at end portions of the arm so as to be pivotable, having an elongated hole extending in a longitudinal direction thereof, and the arm provided with a third protrusion formed on an inner face of the elongated hole in the longitudinal direction;

wherein the operating stick is press-fitted into the insertion hole such that the first protrusion fits on the recessed portion to restrict a press-fitting direction;

wherein the first direction is in parallel with the longitudinal direction;

wherein the second protrusion and the third protrusion are provided so as to prevented from interfering each other when the operating stick penetrates into the arm through the elongated hole in a predetermined direction; and

wherein diameters of the end portions have different diameters.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1A is a plan view of a joystick, which illustrates an embodiment of the invention;

FIG. 1B is a longitudinal sectional view of the joystick, which illustrates the embodiment of the invention;

FIG. 2 is a perspective view of an operating stick shown in FIGS. 1A and 1B;

FIG. 3A is a plan view of a knob, which illustrates the embodiment of the invention;

FIG. 3B is a bottom view of the knob, which illustrates the embodiment of the invention;

FIG. 4A is a perspective view of an arm, which illustrates the embodiment of the invention;

FIG. 4B is a bottom view of the arm, which illustrates the embodiment of the invention;

FIG. 5A is a right side view of a casing, which illustrates the embodiment of the invention;

FIG. 5B is a left side view of the casing, which illustrates the embodiment of the invention;

FIG. 6A is a perspective view of an arm, which illustrates the embodiment of the invention;

FIG. 6B is a bottom view of the arm, which illustrates the embodiment of the invention;

FIG. 7A is a front view of a casing, which illustrates the embodiment of the invention;

FIG. 7B is a rear view of the casing, which illustrates the embodiment of the invention;

FIG. 8A is a plan view of a joystick, which illustrates a related one; and

FIG. 8B is a longitudinal sectional view of the joystick, which illustrates the related one.

### DETAILED DESCRIPTION OF THE PREFERRED EMBODIMENTS

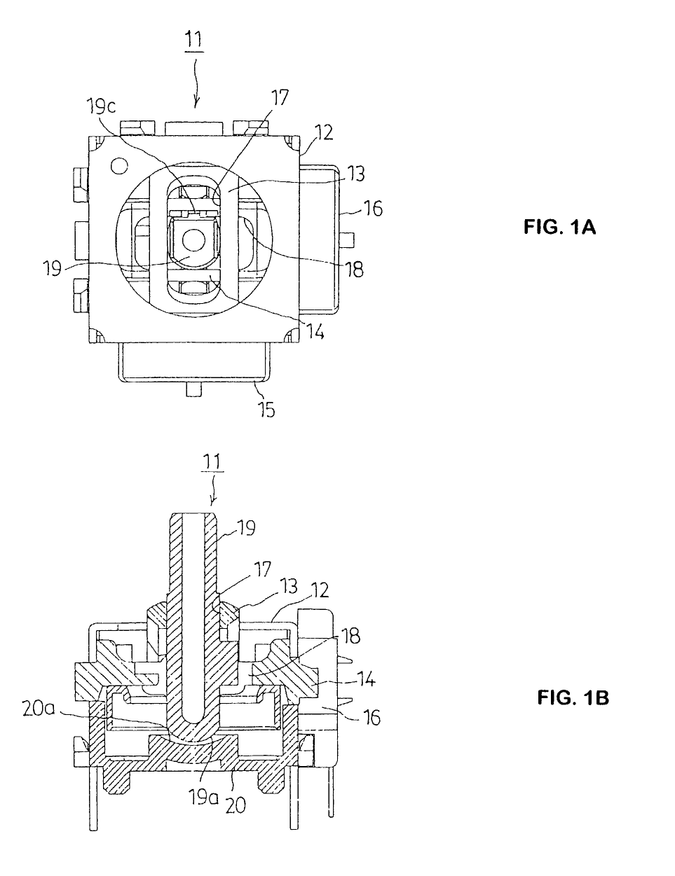

An embodiment of the invention is described in detail with reference to FIG. 1A to FIG. 7B. A joystick 11 is configured so that arms 13 and 14 perpendicular to each other are swingably disposed in the casing 12 in such a way as to be upwardly or downwardly apart from each other in FIGS. 1A and 1B. Further, each of the arms 13 and 14 is pivotally supported at both end portions thereof in the casing 12, and connected to a corresponding one of variable resistors 15 and 16 at an end portion thereof.

Further, each of elongated holes 17 and 18 respectively extending in the axis directions of the arms 13 and 14 is dug in the central portion of a corresponding one of the arms 13 and 14. An operating stick 19 is provided in such a manner as to penetrate through the elongated holes 17 and 18. Moreover, the bottom end portion of the operating stick 19 is formed as a convex spherical portion 19a. On the other hand, a concave spherical portion 20a is formed in the central part of the bottom plate 20 of the joystick 11. The convex spherical portion 19a is swingably put on the convex spherical portion 20a. Incidentally, a knob (not shown) is fitted into the top end portion of the operating stick 19.

Therefore, when the operating stick 19 is operated in the joystick 11, the operating stick 19 swings around the concave spherical portion 20a employed as a swinging fulcrum. Thus, the arms 13 and 14 are swung, and the variable resistors 15 and 16 respectively connected to the arms 13 and 14 are turned. Thus, the variable resistors 15 and 16 generate outputs in response to an operation of the operating stick 19.

Regulating portions for restricting the assembling direction to a predetermined direction is provided in the joystick 11 so as to prevent an occurrence of misassembly thereof. Thus, various kinds of improvements are made to the shapes of components to be assembled.

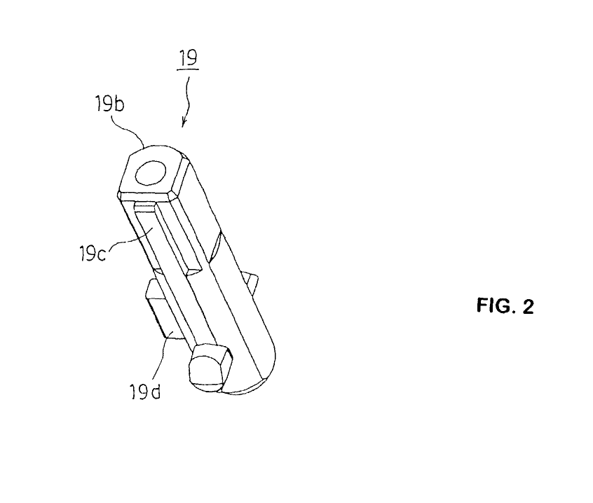

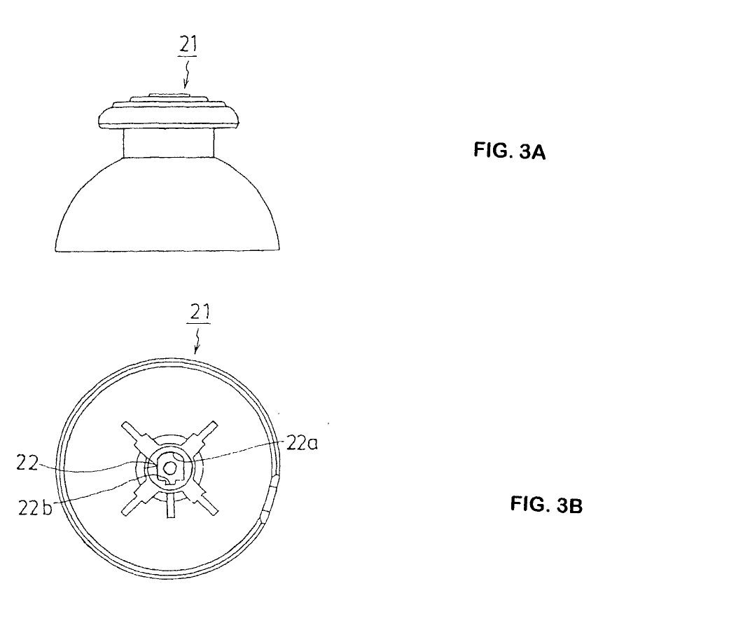

That is, as illustrated in FIG. 2, the operating stick 19 is formed like a pole whose transversal section is surrounded by three side edges and one circular arc side edge 19b. Furthermore, a protrusion 19c projecting from a side face corresponding to a side edge facing the circular arc side edge 19b. On the other hand, as illustrated in FIG. 3, a press-fitting portion 22 provided with a concave circular arc side 22a and a recessed portion 22b, which respectively correspond to the circular arc side edge 19b and the protrusion 19, is formed in a knob 21.

Therefore, the operating stick 19 is press-fitted into the knob 21 by positioning the convex circular arc side edge 19b and the protrusion 19c on the concave circular arc side edge 22a and the recessed portion 22b respectively. Thus, the operating stick 19 is press-fitted thereinto so as to restrict a press-fitted direction, in which the operating stick 19 is press-fitted, to one direction. Thus, an occurrence of misattachment of the operating stick 19 can be prevented.

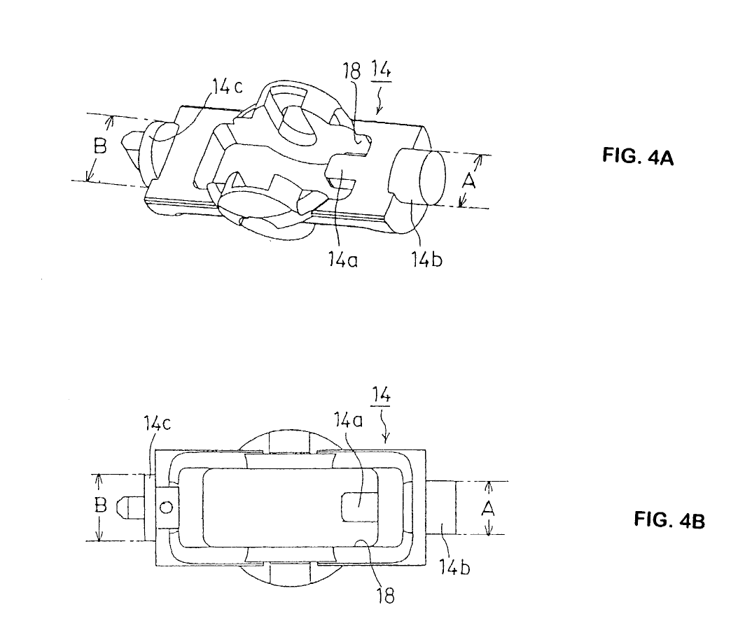

Further, as illustrated in FIGS. 2, 4A and 4B, a projecting portion 14a protruding in the direction of an axis thereof by a predetermined length is provided in an elongated hole 18 of the arm 14. Moreover, a projecting portion 19d of a predetermined length perpendicular to the direction of an axis of the operating stick 19 is formed at a lower part of the operating stick 19. When the operating stick 19 is caused to penetrate through the elongated hole 18, the stick 19 is made to penetrate therethrough in a direction, in which the projecting portions 14a and 19d are prevented from interfering with each other, that is, in a direction, in which the projecting portions 14a and 19d go away from each other. Therefore, the operating stick 19 is caused to penetrate through the elongated hole 18 of the arm 14 in a direction that is restricted to the predetermined direction. Consequently, an occurrence of misattachment of the operating stick 19 can be prevented.

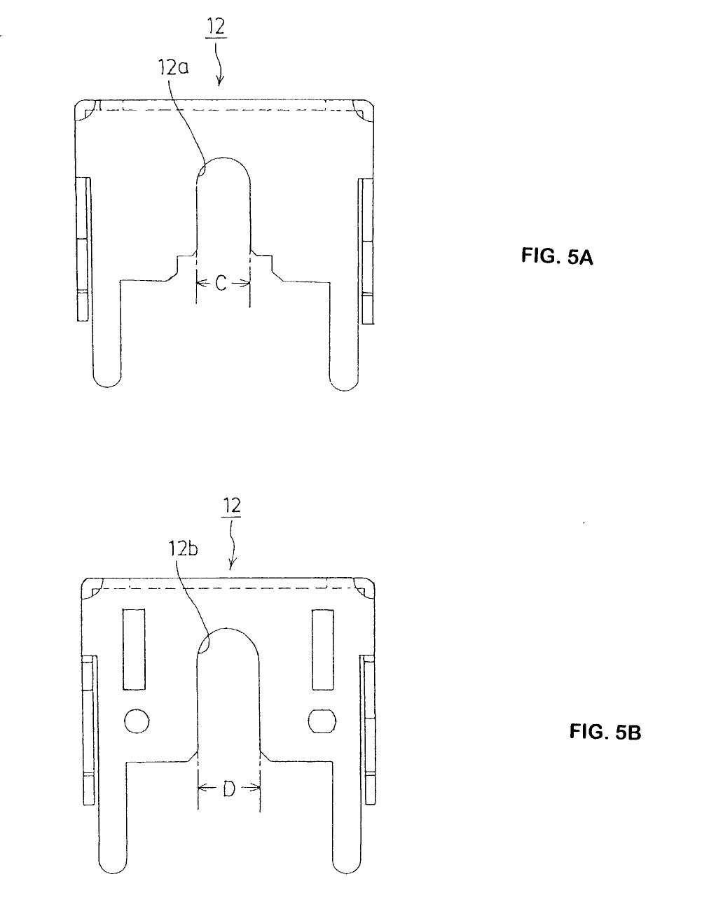

Furthermore, as illustrated in FIGS. 4A, 4B, 5A, and 5B, the arm 14 is formed so that the diameters A and B of both end portions 14b and 14c thereof have different dimensions. On the other hand, pivotally supporting portions 12a and 12b of the casing 12 are formed in such a manner as to have predetermined dimensions C and D respectively corresponding to the shaft diameters A and B. Hence, the arm 14 is attached to the casing 12 so as to restrict an attachment direction, in which the arm 14 is attached thereto, to the predetermined direction. Consequently, an occurrence of misattachment of the arm 14 can be prevented.

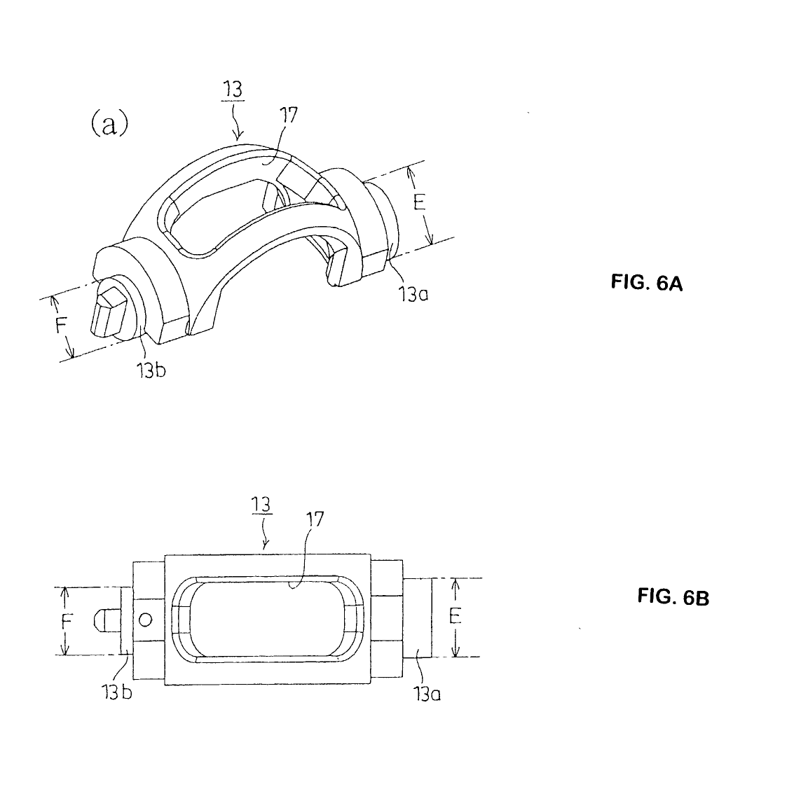

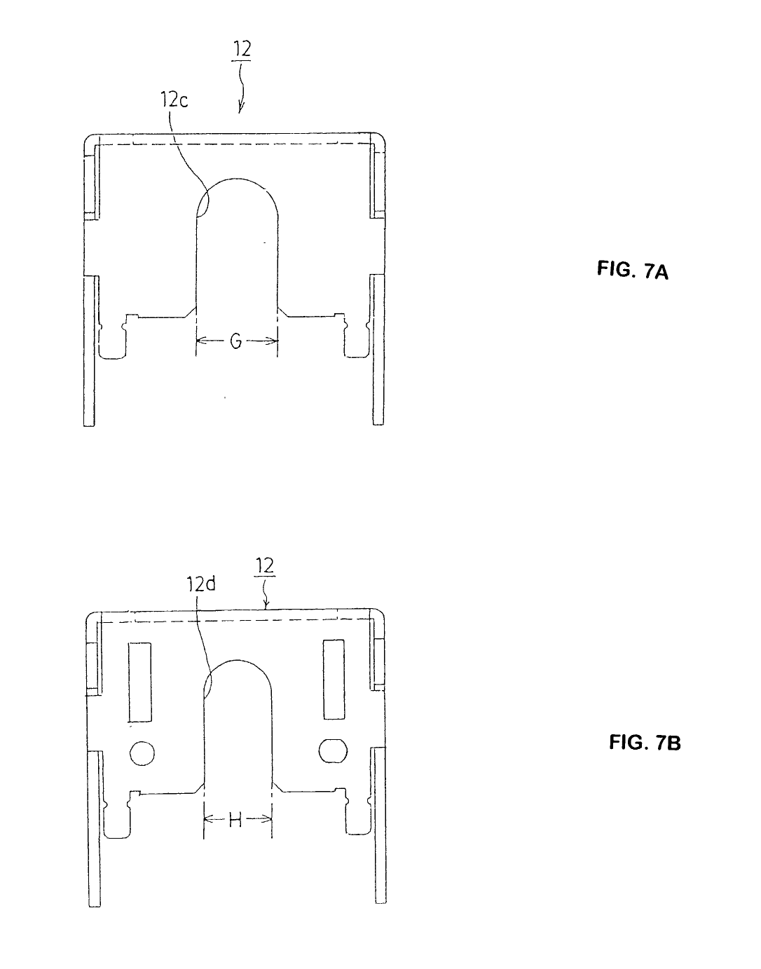

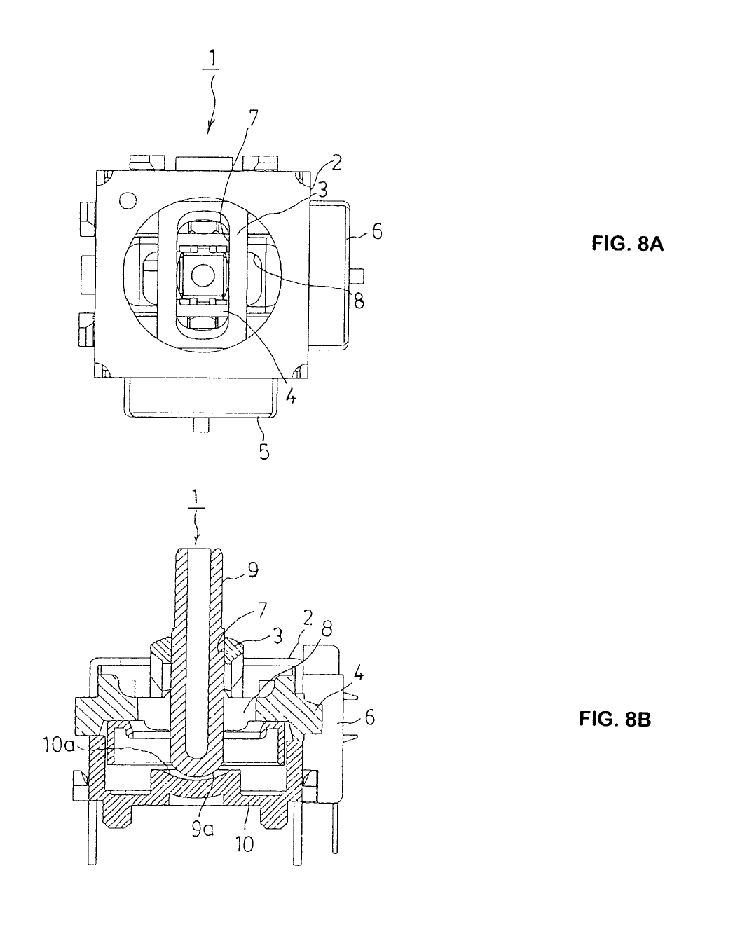

Further, as illustrated in FIGS. 6A, 6B, 7A, and 7B, the arm 13 is formed so that the diameters E and F of both end portions 13a and 13b thereof have different dimensions. On the other hand, pivotally supporting portions 12c and 12d of the casing 12 are formed in such a manner as to have predetermined dimensions G and H respectively corresponding to the shaft diameters E and F. Therefore, the arm 13 is attached to the casing 12 so as to restrict an attachment direction, in which the arm 13 is attached thereto, to the predetermined direction. Thus, an occurrence of misattachment of the arm 13 can be prevented. Furthermore, the shaft diameters E and F of the arm 13 and the shaft diameters A and B of the arm 14 have different dimensions. Consequently, misattachment of the arms 13 and 14 to be caused by taking the arm 13 for the arm 14 does not occur.

Incidentally, various changes and modifications may be made without departing from the spirit of the invention. Further, needless to say, the invention covers the changes and modifications.

What is claimed is:

1. A joystick, comprising:
a knob, having a insertion hole, provided with a first restriction portion on an inner face of the insertion hole; and
an operating stick, having a second restriction portion, press-fitting into the insertion hole;
wherein the first restriction and the second restriction portion restrict a press-fitting direction when the operating stick is press-fitted into the insertion hole.

2. The joystick as set forth in claim 1, wherein the first restriction portion is a recessed portion formed on the inner face of the insertion hole; and
wherein the second restriction portion is a protrusion formed on the operating stick so as to fit on the recessed portion.

3. A joystick, comprising:
an operating stick, having a third restriction portion; and
an arm, having an elongated hole extending in a longitudinal direction thereof, the arm provided with a fourth restriction portion formed on an inner face of the elongated hole;
wherein the third restriction portion and the fourth restriction portion restrict the penetration direction when the operating stick penetrates the arm through the elongated hole.

4. The joystick as set forth in claim 3, wherein the third restriction portion is a first protrusion formed on the operating stick in the longitudinal direction;
wherein the fourth restriction portion is a second protrusion formed on the inner face of the elongated hole in the longitudinal direction so as to prevent from interfering the first protrusion with the second protrusion when the operating stick penetrates into the arm through the elongated hole in a predetermined direction.

5. A joystick, comprising:
a casing; and
an arm, supported on the casing at end portions of the arm so as to be pivotable, the arm having a fifth restriction portion to restrict a supporting direction of the arm with respect to the casing.

6. The joystick as set forth in claim 5, wherein the fifth restriction portion is the end portions of the arm in which diameters of the end portions have different diameters.

7. A joystick, comprising:
a knob, having an insertion hole, provided with a recessed portion on an inner face of the insertion hole;
an operating stick, having a first protrusion, press-fitting into the insertion hole, having a second protrusion extending in a first direction;
a casing; and
an arm, supported on the casing at end portions of the arm so as to be pivotable, having an elongated hole extending in a longitudinal direction thereof, and the arm provided with a third protrusion formed on an inner face of the elongated hole in the longitudinal direction;
wherein the operating stick is press-fitted into the insertion hole such that the first protrusion fits on the recessed portion to restrict a press-fitting direction;
wherein the first direction is in parallel with the longitudinal direction;
wherein the second protrusion and the third protrusion are provided so as to prevented from interfering each other when the operating stick penetrates into the arm through the elongated hole in a predetermined direction; and
wherein diameters of the end portions have different diameters.
